(19) United States
(12) Patent Application Publication
(10) Pub. No.: US 2025/0138143 A1
(43) Pub. Date: May 1, 2025

(54) VEHICULAR RADAR SENSOR WITH RADOME HAVING INTEGRATED STRUCTURE

(71) Applicant: Magna Electronics Inc., Auburn Hills, MI (US)

(72) Inventor: Ha Bui-Van, Aschaffenburg (DE)

(21) Appl. No.: 18/910,020

(22) Filed: Oct. 9, 2024

Related U.S. Application Data
(60) Provisional application No. 63/593,259, filed on Oct. 26, 2023.

(51) Int. Cl. G01S 7/03; G01S 13/931

(52) U.S. Cl. CPC G01S 7/032; G01S 13/931; G01S 2013/93271; G01S 2013/93275

(57) ABSTRACT

A vehicular radar sensor includes transmitters and receivers, a printed circuit board (PCB), and a radome at least partially enclosing (i) the PCB, (ii) the transmitters and (iii) the receivers. The radome includes an internal surface nearest the PCB and an external surface farthest from the PCB. The radome includes a plurality of cavities at the internal side of the radome that extend partially but not entirely through a thickness of the radome. A first portion of the radio signals passes through the plurality of cavities when passing through the radome to be received by the receivers, and a second portion of the radio signals does not pass through the plurality of cavities when passing through the radome to be received at the receivers. Radar data captured by the vehicular radar sensor is based on (i) the first portion of radio signals and (ii) the second portion of radio signals.

### CROSS REFERENCE TO RELATED APPLICATION

The present application claims the filing benefits of U.S. provisional application Ser. No. 63/593,259, filed Oct. 26, 2023, which is hereby incorporated herein by reference in its entirety.

### FIELD OF THE INVENTION

The present invention relates generally to a vehicle sensing system for a vehicle and, more particularly, to a vehicle sensing system that utilizes one or more radar sensors at a vehicle.

### BACKGROUND OF THE INVENTION

Use of radar sensors in vehicle sensing systems is common and known. Examples of such known systems are described in U.S. Pat. Nos. 9,146,898; 8,027,029 and/or 8,013,780, which are hereby incorporated herein by reference in their entireties.

### SUMMARY OF THE INVENTION

A vehicular radar sensor includes a plurality of transmitters that transmit radio signals and a plurality of receivers that receive radio signals. The vehicular radar sensor also includes a printed circuit board (PCB) with electronic circuitry and associated software. The vehicular radar sensor includes a radome at least partially enclosing (i) the PCB, (ii) the plurality of transmitters and (iii) the plurality of receivers. The radome includes an internal side nearest the PCB, and the radome includes an external side farthest from the PCB that is separated from the internal side by a thickness of the radome. The radome includes a plurality of cavities at the internal side of the radome that extend partially but not entirely through the thickness of the radome. A first portion of the radio signals incident at the external side of the radome enters the radome and passes through the plurality of cavities when passing through the radome to be received by the receivers, and a second portion of the radio signals incident at the external side of the radome enters the radome and does not pass through the plurality of cavities when passing through the radome to be received at the receivers. Radar data captured by the vehicular radar sensor is based on (i) the first portion of radio signals that pass through the radome and (ii) the second portion of radio signals that pass through the radome.

These and other objects, advantages, purposes and features of the present invention will become apparent upon review of the following specification in conjunction with the drawings.

### BRIEF DESCRIPTION OF THE DRAWINGS

FIG. 1 is a perspective view of a vehicle with a sensing system that incorporates a radar sensor;

FIGS. 2A and 2B are cross-section views of a radar sensor with a radome;

FIGS. 3A and 3B are a schematic views of a plastic radome substrate and a radome with integrated structures;

FIGS. 4A-4C are additional views of the radome with integrated structures;

FIG. 5 is a schematic view of dimensions of integrated structures of a radome;

FIGS. 6A and 6B are schematic views of incident waves reflecting off a conventional radome and a radome with integrated structures; and

FIG. 7 is a plot of reflection values for a conventional radome and a radome with integrated structures.

### DESCRIPTION OF THE PREFERRED EMBODIMENTS

A vehicle vision system and/or driver or driving assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. Optionally, the vision system may provide a display, such as a rearview display or a top down or bird's eye or surround view display or the like.

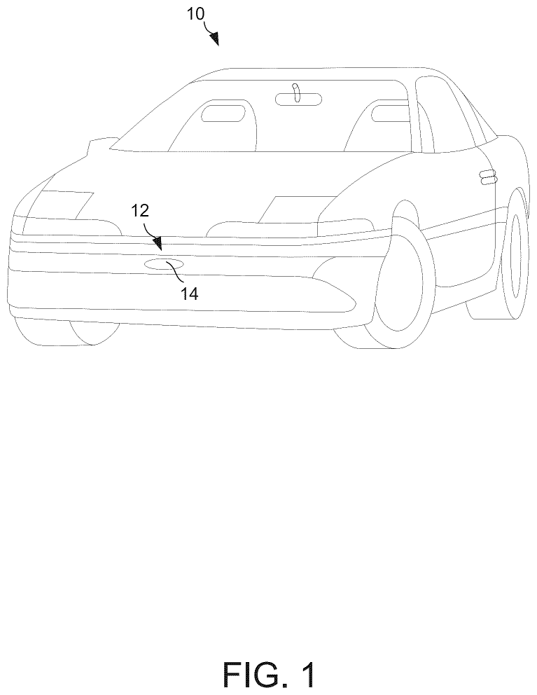

Referring now to the drawings and the illustrative embodiments depicted therein, a vehicle 10 (FIG. 1) includes a driving assistance system or sensing system 12 that includes at least one radar sensor unit, such as a forward facing radar sensor unit 14 (and the system may optionally include multiple exterior facing sensors, such as cameras, radar sensors, LIDAR sensors, or other sensors, such as a rearward facing sensor at the rear of the vehicle 10, and a sideward/rearward facing sensor at respective sides of the vehicle 10), which senses regions exterior of the vehicle 10. The sensing system 12 includes a control or electronic control unit (ECU) that includes a data processor that is operable to process data captured by the radar sensor(s). The sensing system 12 may also include a radar sensor that includes a plurality of transmitters that transmit radio signals via a plurality of antennas. The radar sensor also includes a plurality of receivers that receive radio signals via the plurality of antennas. The received radio signals are transmitted radio signals that are reflected from an object. The ECU or processor is operable to process the received radio signals to sense or detect the object that the received radio signals reflected from. The ECU or sensing system 12 may be part of a driving assist system of the vehicle 10, with the driving assist system controlling at least one function or feature of the vehicle 10 (such as to provide autonomous driving control of the vehicle 10) responsive to processing of the data captured by the radar sensors. The data transfer or signal communication from the sensor to the ECU may comprise any suitable data or communication link, such as a vehicle network bus or the like of the equipped vehicle 10.

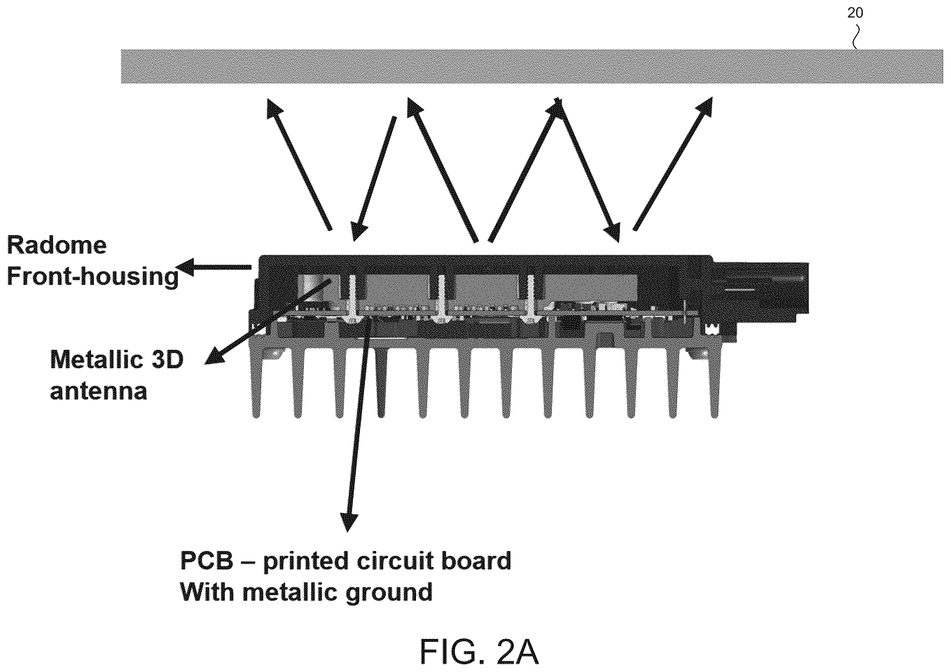

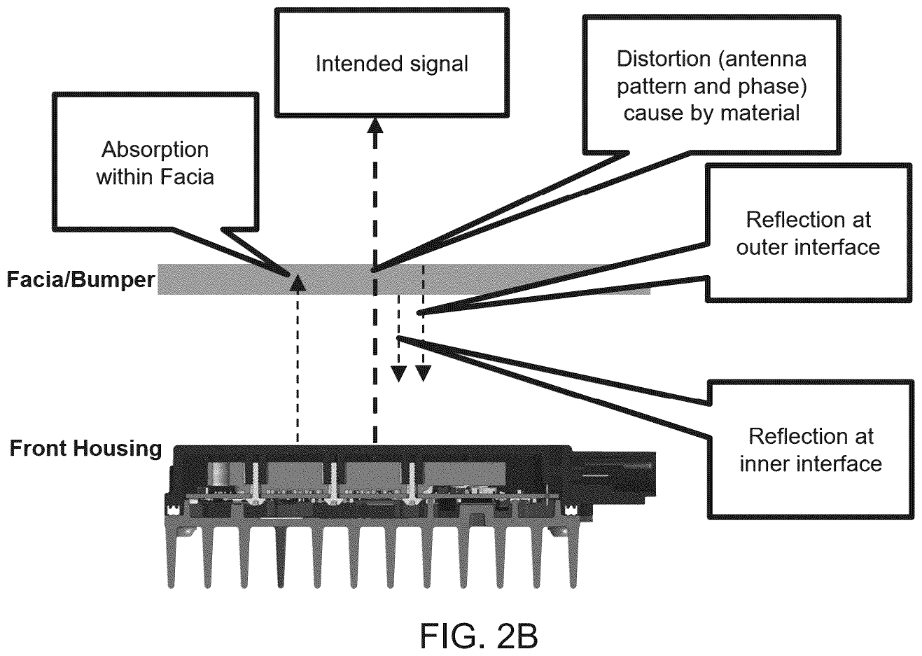

Many modern vehicles include one or more radar sensors disposed at the front, rear, and/or corners of the vehicle. These radar sensors are often integrated into or behind bumpers and/or fascias of the vehicle, which may include the vehicle's front or rear bumper, grille, headlamps or tail lamps, aerodynamic features, and other components associated with the front or rear of the vehicle. For example, the radar sensor may be disposed behind the fascia of the vehicle for aesthetic purposes and to protect the radar sensor from damage. However, this causes radio signals transmitted by the radar sensor and received by the radar sensor to pass through the fascia, which impacts propagation of the signals. As shown in FIGS. 2A and 2B, a fascia 20 causes reflection, absorption, and/or distortion of radio signals based on the incident angles, antenna gain patterns, and phase delay. This translates to loss in radio frequency (RF) transmission and reception, which reduces the detection range for target objects (i.e., radar cross section (RCS)).

The bumper or other fascia is often co-designed to optimize the transmission of Radio Frequency (RF) energy of the radar to the external environment. Despite this optimization, it is unavoidable to have reflection, especially when an incident wave is at an angle (FIG. 2A), thus some energy reflects back to the radar sensor. The radar sensor generally includes a radome (i.e., a structural and/or weatherproofing enclosure for protecting the radar sensor), an antenna, and a printed circuit board (PCB), which then again reflects some or most of the reflected energy back toward the fascia 20. This sequence repeats and may create a standing wave between the radar sensor and the fascia 20, resulting in some ripples and/or deep notches in the antenna pattern, thus impacting the performance of the radar sensor.

Some techniques to reduce these reflections involve including an absorber within the radar sensor. However, the use of an absorber has inherent drawbacks. For example, the absorber incurs additional cost and additional manufacture or installation time. Additionally, distance between the radome and the antenna is usually limited within one to two millimeters. Because of this, the absorption is less effective. Thus, it is desirable and advantageous to suppress these standing waves by eliminating or reducing the reflection of the radar signals off the fascia and/or radar sensor. In other words, it is desirable to reduce the reflectivity of the radar or its equivalent Radar Cross Section (RCS), as this improves efficiency and signal clarity. Because the radar sensor itself is a target of reflected waves, the RCS of the radar sensor represents the reflectivity of the radar body under the incident wave.

Thus, the integration of an automotive radar sensor behind a bumper or other fascia of a vehicle often causes degradation of radar performance due to the multiple reflections between the bumper/fascia surface and the radar sensor itself. The impact may include ripples in antenna patterns, notches in patterns in particular directions, changes of phase of the radio signals. These effects may cause a false alarm or ghost target when processing the radio signals for objects. Implementations herein address these issues with a radar sensor that includes a radome with low reflectivity or RCS. Optionally, the radar sensor includes a metallic antenna with a three-dimensional (3D) plastic radome (i.e., radar dome) that at least partially covers or encapsulates a front surface of a PCB and/or an antenna (i.e., transmitters and receivers) of the radar sensor.

Within the radome described herein, there are periodic structures that create blind holes (i.e., cavities, openings, recesses, depressions, or the like) within the radome that alternate the incident wave to the radar sensor. That is, the radome of the radar sensor provides a periodic structure which alternates/modifies the incident wave to the radar sensor, thus reflecting less energy/power back to the surrounding environment. The reduction of the reflected energy improves the integration of the radar sensor behind the plastic bumper of the vehicle, where some part of the power from the radar sensor is inevitably reflected toward the radar sensor from the bumper surface.

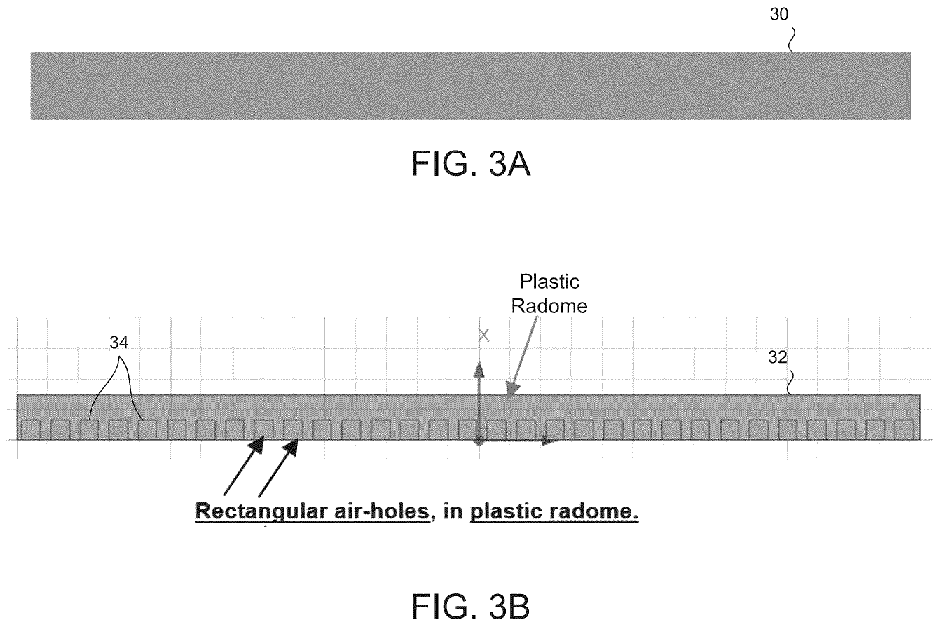

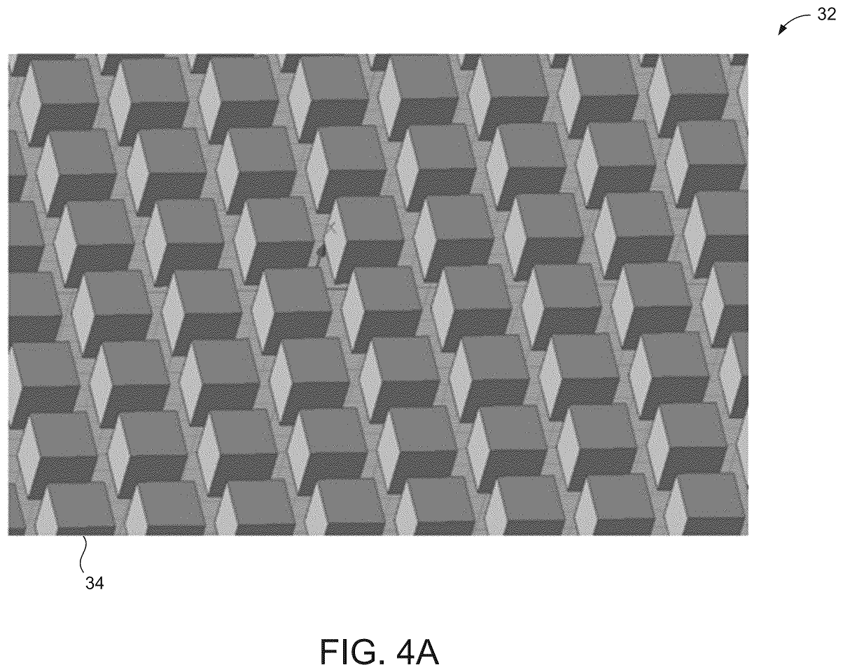

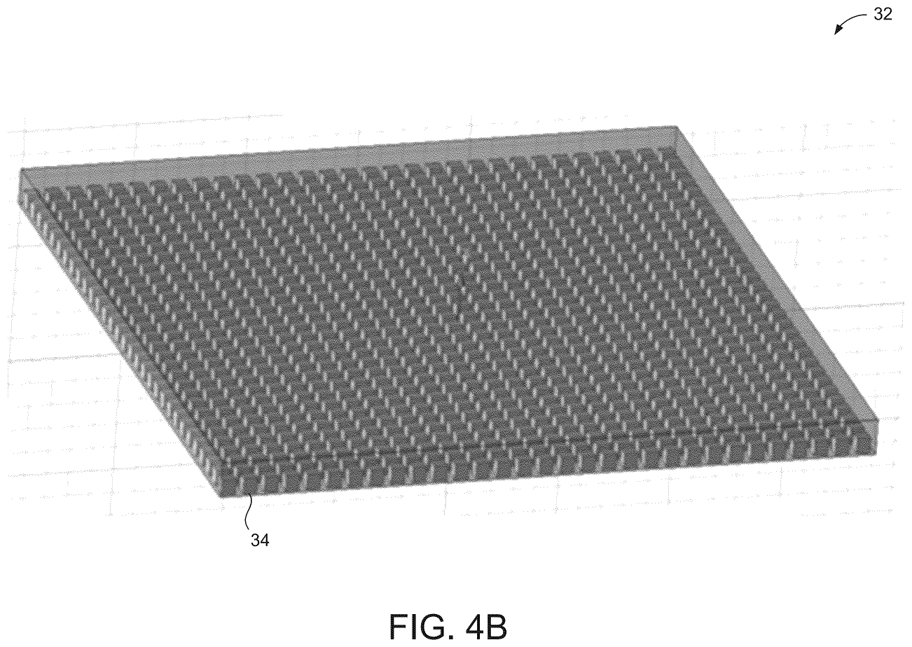

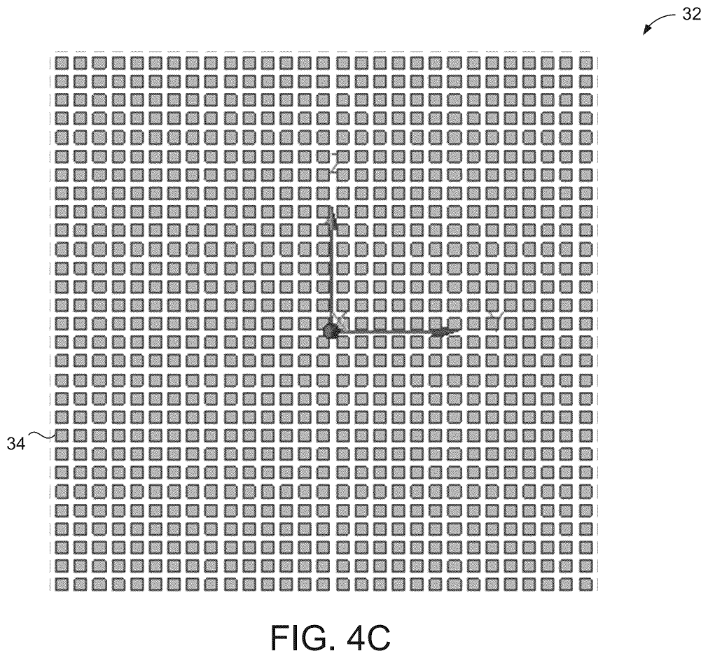

Referring now to FIG. 3A, a standard radome 30 may be seen as a dielectric strip or slab. Such a radome will uniformly reflect waves (i.e., the reflections are in-phase with each other). In contrast, as shown in FIG. 3B, the radome 32 of the implementations discussed herein includes integrated periodic structures 34 or blind holes within the radome 32. Each structure 34 (i.e., each blind hole or cavity) extends only partially through the radome 32 such that the radome 32 is still impermeable to gasses and liquids. That is, the radome 32 includes an inner surface (nearest and facing the PCB/antennas) and an outer surface (farthest from the PCB and facing away from the vehicle) separated by a thickness of the radome substrate. Each cavity extends only partially through the radome substrate. In this example, the structures 34 may be arranged in a two-dimensional array of rows and columns with uniform size and separation. In other examples, the structures 34 may be distributed non-uniformly, such that the structures 34 are located in regions of the radome 32 where standing waves or reflected waves occur. These structures 34 may be of any shape, such as a box or cube shape, a cuboid shape, a polyhedral prism shape, a cylindrical shape, etc. Each structure 34 may be filled with a metallic counterpart from the antenna (i.e., conductive/reflective material in electrical contact with the antennas or “nails” of the antennas/transmitters/receivers). In this scenario, the surface of the antenna can be thought of as extending to the structure 34. In other examples, each structure 34 is metalized (i.e., an inner or internal surface of the structure 34 is coated with a thin layer of metal or other reflective material and is otherwise filled with air or other ambient gasses). In still other examples, the structures 34 may be filled with a second material other than the material of the radome 32, where the second material's refractive index causes the desired reflection of the incident waves. FIGS. 4A-4C illustrate additional views of the radome 32 and structures 34. Each structure 34 may be referred to as a blind hole which represents an empty (or air-volume) space within the radome 32 (or, alternatively, filled with nails extending from the antennas or a second material that differs from the material of the radome 32).

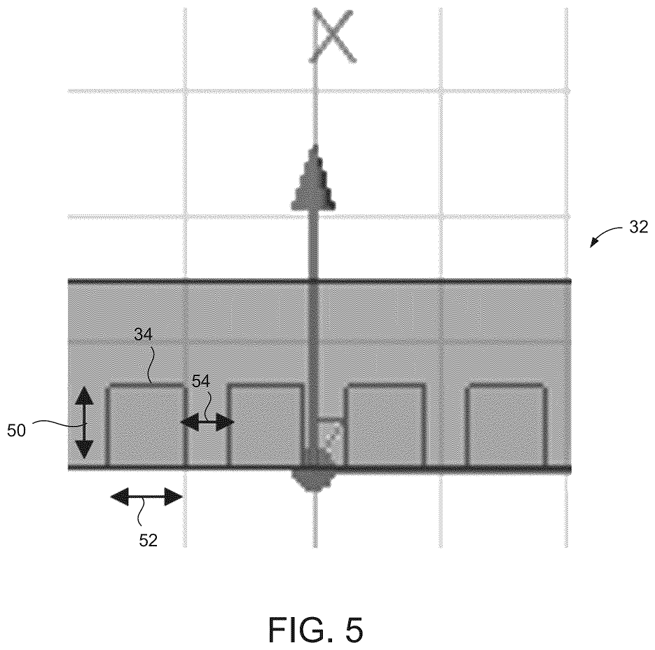

Referring now to FIG. 5, the size or dimensions and/or separation of each structure 34 of the radome 32 may be configured or tailored based on the operating parameters of the radar sensor. For example, the dimensions may be based on a frequency of interest for the radar sensor (e.g., a frequency that the radar sensor operates at, such as a frequency the radar sensor emits radio signals at). In some examples, a height of each structure 34, represented by dimension 50 (i.e., the dimension that the thickness of the radome 32 between the inner surface and the outer surface is measured against), may be approximately λ divided by eight to λ divided by two. Here, λ represents the speed of light divided by the frequency of interest. A width of each structure 34, represented by dimension 52, may be approximately/divided by eight to λ divided by two. A depth of each structure 34 may be approximately/divided by eight to λ divided by two. A space or gap between structures 34, represented by dimension 54, may be approximately λ divided by eight to λ divided by two.

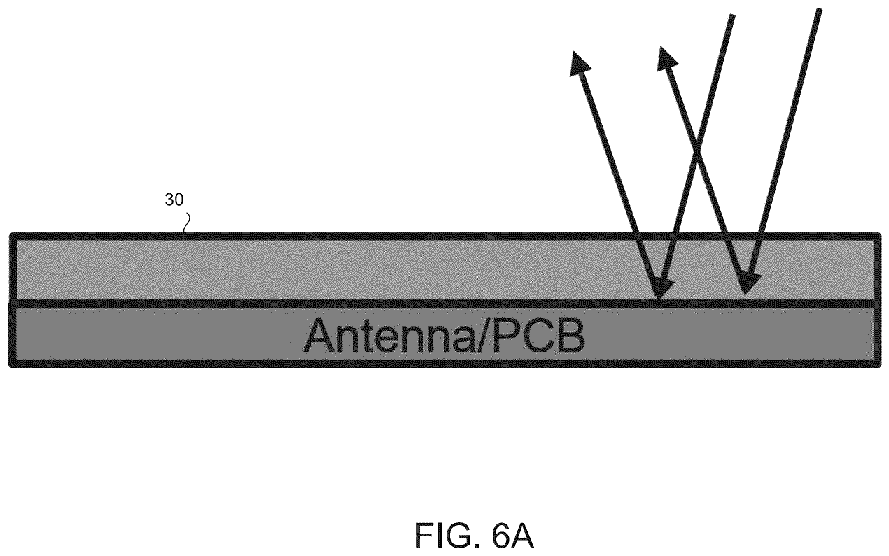

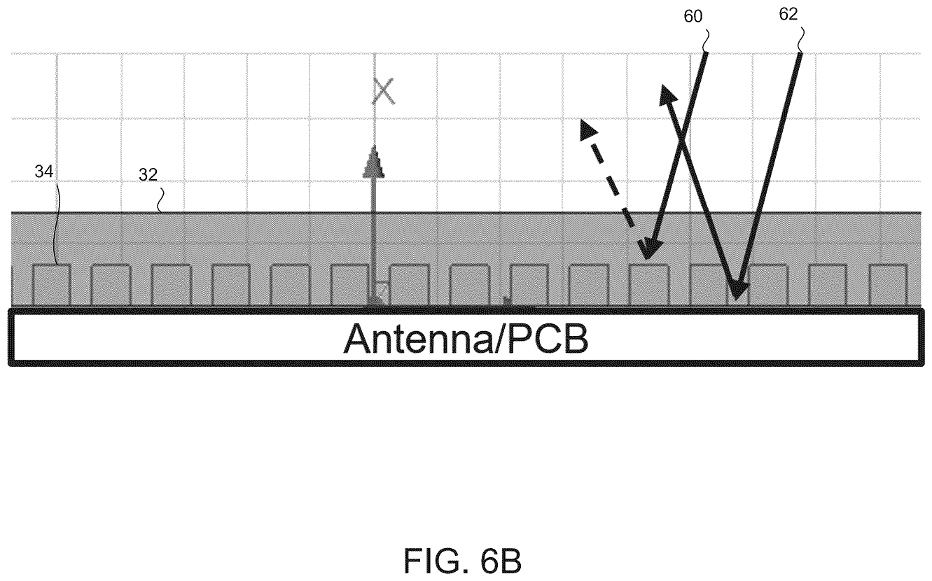

Referring now to FIG. 6A, in the radome substrate 30, incident waves travel through the radome 30 and reflect at the antenna/PCB surface. These reflections are “in-phase” and thus, after reflecting again off the inner surface of the bumper or fascia (or other object), add to one another and thus increase the reflections and signals in the field of sensing of the radar sensor and add to the reflections received by the antenna/PCB. This increases the amount of noise received by the radar sensor. In contrast, and as shown in FIG. 6B, the radome 32 includes the structures 34. Here, incident waves from the external environment impinge on the radome 32 and experience or result in different reflections. For example, the waves that hit the structures 34, such as wave 60, reflect earlier compared to waves, such as wave 62, that pass through the radome 32 (without striking or reflecting off the structures 34) to reflect off the antenna surface (i.e., an outer surface of the PCB that is closest to the internal side or surface of the radome) because wave 60 travels less distance before reflecting than wave 62. That is, wave 60 reflects earlier than wave 62 because wave 60 reaches its reflective surface (i.e., the structure 34) before the wave 62 reaches its reflective surface (i.e., the antenna/PCB). Because the waves 60, 62 have different “lengths” (i.e., travel different distances), the reflected phase for each wave 60, 62 is different. The design/dimensions of the structures 34 may thus be configured to control the reflected phase. Accordingly, the dimensions of the structures 34 may be configured or designed to cause the reflections off the structures 34 (i.e., the wave 60) to have the opposite phase of waves that reflect off the antennas (i.e., the wave 62). That is, the phase may be different by 180 degrees. This minimizes the reflected waves via destructive summation, which results in less reflections, noise, and distortion for the radome 32 compared to a conventional radome 30.

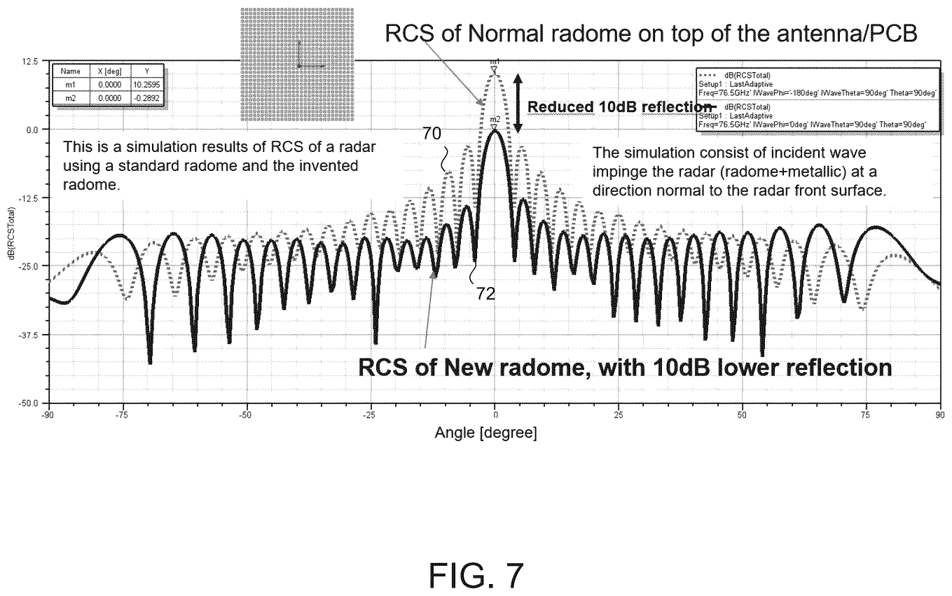

Referring now to FIG. 7, a plot of simulated RCS for both a conventional radome 30 and the improved radome 32 (i.e., with the structures 34) is illustrated. Here, the conventional radome 30 (see plot 70) has 10 dB greater (i.e., worse) reflections than the improved radome 32 (see plot 72).

Thus, implementations herein include a radar sensor that includes a radome with periodic “blind holes” or other structures. An inner or internal surface of these structures may be metalized. In other implementations, the radome includes blind holes or other structures, formed using injection molding or similar approaches, without metallization of the blind holes. In these implementations, the antenna is produced/manufactured with a complementary part to the blind holes (i.e., nails). That is, in these examples, metallic extensions of the antenna extend into and occupy/fill a portion or the entirety of each blind hole. These metallic nails from the antenna, when fit into the blind holes from the radome, act as a reflective surface that reflects waves with a different phase than waves that reflect off other portions of the antenna.

The radome can be used as housing for the radar sensor, which offers low-reflection (i.e., low RCS) capabilities for the radar sensor. The radome can be installed at the radar sensor without additional effort. Additionally, the radar with low RCS improves the integration impact when placing the radar behind the plastic bumper/fascia. The performance is therefore improved, and ghost targets/false alarms are less likely. This improves the safety of the driver and occupants within the cars equipped with radars, especially for autonomous driving cars.

Although the sensor or system has been described in the context of radar and radio waves, the sensor or system is applicable to any type of wave within the electromagnetic spectrum. The radar sensor may include a plurality of cavities (e.g., the structures 34), such that each cavity of the plurality of cavities has a depth dimension and a width dimension that is the same as the depth dimension and the width dimension of each other cavity. The depth dimension and the width dimension may be based on an operating frequency of the vehicular radar sensor. In further examples, each cavity is separated from an adjacent cavity by a gap dimension, where the gap dimension is based on the operating frequency of the vehicular radar sensor.

In some examples, the radome includes a plastic material. In other examples, the radome may include a composite material. Optionally, a portion of the transmitters and a portion of the receivers of the antenna extend into each cavity of the plurality of cavities (i.e., nails). In further examples, the plurality of cavities is arranged in an array, and the array includes a plurality of rows and a plurality of columns.

In some examples, the vehicular radar sensor is disposed behind a bumper of a vehicle. In other examples, the vehicular radar sensor is disposed behind a fascia of a vehicle. Each cavity may be filled with a material having a refractive index different from the refractive index of the radome.

The system may utilize sensors, such as radar sensors or imaging radar sensors or lidar sensors or the like, to detect presence of and/or range to objects and/or other vehicles and/or pedestrians. The sensing system may utilize aspects of the systems described in U.S. Pat. Nos. 11,536,829; 10,866,306; 9,954,955; 9,869,762; 9,753,121; 9,689,967; 9,599,702; 9,575,160; 9,146,898; 9,036,026; 8,027,029; 8,013,780; 7,408,627; 7,405,812; 7,379,163; 7,379,100; 7,375,803; 7,352,454; 7,340,077; 7,321,111; 7,310,431; 7,283,213; 7,212,663; 7,203,356; 7,176,438; 7,157,685; 7,053,357; 6,919,549; 6,906,793; 6,876,775; 6,710,770; 6,690,354; 6,678,039; 6,674,895 and/or 6,587,186, and/or U.S. Publication Nos. US-2019-0339382; US-2018-0231635; US-2018-0045812; US-2018-0015875; US-2017-0356994; US-2017-0315231; US-2017-0276788; US-2017-0254873; US-2017-0222311 and/or US-2010-0245066, which are hereby incorporated herein by reference in their entireties.

The radar sensors of the sensing system each comprise a plurality of transmitters that transmit radio signals via a plurality of antennas, a plurality of receivers that receive radio signals via the plurality of antennas, with the received radio signals being transmitted radio signals that are reflected from an object present in the field of sensing of the respective radar sensor. The system includes an ECU or control that includes a data processor for processing sensor data captured by the radar sensors. The ECU or sensing system may be part of a driving assist system of the vehicle, with the driving assist system controlling at least one function or feature of the vehicle (such as to provide autonomous driving control of the vehicle) responsive to processing of the data captured by the radar sensors.

The ECU may be operable to process data for at least one driving assist system of the vehicle. For example, the ECU may be operable to process data (such as image data captured by a forward viewing camera of the vehicle that views forward of the vehicle through the windshield of the vehicle) for at least one selected from the group consisting of (i) a headlamp control system of the vehicle, (ii) a pedestrian detection system of the vehicle, (iii) a traffic sign recognition system of the vehicle, (iv) a collision avoidance system of the vehicle, (v) an emergency braking system of the vehicle, (vi) a lane departure warning system of the vehicle, (vii) a lane keep assist system of the vehicle, (viii) a blind spot monitoring system of the vehicle and (ix) an adaptive cruise control system of the vehicle. Optionally, the ECU may also or otherwise process radar data captured by a radar sensor of the vehicle or other data captured by other sensors of the vehicle (such as other cameras or radar sensors or such as one or more lidar sensors of the vehicle). Optionally, the ECU may process captured data for an autonomous control system of the vehicle that controls steering and/or braking and/or accelerating of the vehicle as the vehicle travels along the road.

The radar sensor or sensors may be disposed at the vehicle so as to sense interior or exterior of the vehicle. For example, the radar sensor may comprise a front sensing radar sensor mounted at a grille or front bumper of the vehicle, such as for use with an automatic emergency braking system of the vehicle, an adaptive cruise control system of the vehicle, a collision avoidance system of the vehicle, etc., or the radar sensor may be comprise a corner radar sensor disposed at a front corner or rear corner of the vehicle, such as for use with a surround vision system of the vehicle, or the radar sensor may comprise a blind spot monitoring radars disposed at a rear fender of the vehicle for monitoring sideward/rearward of the vehicle for a blind spot monitoring and alert system of the vehicle. Optionally, the radar sensor or sensors may be disposed within the vehicle so as to sense interior of the vehicle, such as for use with a cabin monitoring system of the vehicle or a driver monitoring system of the vehicle or an occupant detection or monitoring system of the vehicle. The radar sensing system may comprise multiple input multiple output (MIMO) radar sensors having multiple transmitting antennas and multiple receiving antennas.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular radar sensor, the vehicular radar sensor comprising:
a plurality of transmitters that transmit radio signals and a plurality of receivers that receive radio signals;
a printed circuit board (PCB) comprising electronic circuitry and associated software;
a radome at least partially enclosing (i) the PCB, (ii) the plurality of transmitters and (iii) the plurality of receivers;
wherein the radome comprises an internal side nearest the PCB, and wherein the radome comprises an external side farthest from the PCB that is separated from the internal side by a thickness of the radome;
wherein the radome comprises a plurality of cavities at the internal side of the radome that extend partially but not entirely through the thickness of the radome;
wherein a first portion of the radio signals incident at the external side of the radome enters the radome and passes through the plurality of cavities when passing through the radome to be received by the receivers, and wherein a second portion of the radio signals incident at the external side of the radome enters the radome and does not pass through the plurality of cavities when passing through the radome to be received at the receivers; and
wherein radar data captured by the vehicular radar sensor is based on (i) the first portion of radio signals that pass through the radome and (ii) the second portion of radio signals that pass through the radome.

2. The vehicular radar sensor of claim 1, wherein each cavity of the plurality of cavities has a depth dimension, a height dimension, and a width dimension that is the same as the depth dimension, the height dimension, and the width dimension of each other cavity of the plurality of cavities.

3. The vehicular radar sensor of claim 2, wherein the depth dimension, the height dimension, and the width dimension are each based on an operating frequency of the vehicular radar sensor.

4. The vehicular radar sensor of claim 1, wherein each cavity of the plurality of cavities is separated from an adjacent cavity of the plurality of cavities by a gap dimension, and wherein the gap dimension is based on an operating frequency of the vehicular radar sensor.

5. The vehicular radar sensor of claim 1, wherein each cavity of the plurality of cavities has a cube shape.

6. The vehicular radar sensor of claim 1, wherein the radome comprises a plastic material.

7. The vehicular radar sensor of claim 1, wherein a surface of each cavity is at least partially covered by a metallic material.

8. The vehicular radar sensor of claim 1, wherein a portion of the transmitters and a portion of the receivers extend into respective cavities of the plurality of cavities.

9. The vehicular radar sensor of claim 1, wherein individual cavities of the plurality of cavities are arranged in an array, and wherein the array comprises a plurality of rows of cavities and a plurality of columns of cavities.

10. The vehicular radar sensor of claim 1, wherein the vehicular radar sensor is disposed behind a bumper of a vehicle and senses through the bumper of the vehicle.

11. The vehicular radar sensor of claim 1, wherein the vehicular radar sensor is disposed behind a fascia of a vehicle and senses through the fascia of the vehicle.

12. The vehicular radar sensor of claim 1, wherein each cavity of the plurality of cavities is at least partially filled with a material having a refractive index different from the refractive index of the radome.

13. The vehicular radar sensor of claim 1, wherein individual cavities of the plurality of cavities are distributed non-uniformly.

14. The vehicular radar sensor of claim 1, wherein radar data captured by the radar sensor is transferred to and processed at an electronic control unit (ECU) of a vehicle for at least one driving assistance system.

15. The vehicular radar sensor of claim 1, wherein radar data captured by the radar sensor is representative of outputs of the receivers.

16. The vehicular radar sensor of claim 1, wherein the electronic circuitry of the PCB comprises a processor operable to process outputs of the receivers, and wherein the radar sensor captures radar data via processing by the processor of the outputs of the receivers.

17. The vehicular radar sensor of claim 1, wherein a third portion of the radio signals incident at the external side of the radome enters the radome and reflects off an internal surface of the cavities that is between the internal side of the radome and the external side of the radome, and wherein a fourth portion of the radio signals incident at the external side of the radome enters the radome and reflects off an outer side of the PCB that is closest to the internal side of the radome, and wherein the third portion of the radio signals has a phase that is different than a phase of the fourth portion of the radio signals.

18. The vehicular radar sensor of claim 17, wherein the difference in phase between the third portion of the radio signals and the fourth portion of the radio signals is 180 degrees.

19. The vehicular radar sensor of claim 17, wherein the third portion of the radio signals at least partially cancels the fourth portion of the radio signals to reduce reflected radio signals within a field of sensing of the vehicular radar sensor.

20. A vehicular radar sensor, the vehicular radar sensor comprising:
a plurality of transmitters that transmit radio signals and a plurality of receivers that receive radio signals;
a printed circuit board (PCB) comprising electronic circuitry and associated software;
a radome at least partially enclosing (i) the PCB, (ii) the plurality of transmitters and (iii) the plurality of receivers;
wherein the radome comprises an internal side nearest the PCB, and wherein the radome comprises an external side farthest from the PCB that is separated from the internal side by a thickness of the radome;
wherein the radome comprises a plurality of cavities at the internal side of the radome that extend partially but not entirely through the thickness of the radome;
wherein radar data captured by the vehicular radar sensor is based on radio signals that (i) are incident at the external side of the radome, (ii) enter the radome and pass through the radome and (iii) are received by the receivers;
wherein a first portion of the radio signals incident at the external side of the radome enters the radome and reflects off an internal surface of the cavities, and wherein a second portion of the radio signals incident at the external side of the radome enters the radome and reflects off an outer side of the PCB that is closest to the internal side of the radome; and
wherein the first portion of the radio signals has a phase that is different than a phase of the second portion of the radio signals.

21. The vehicular radar sensor of claim 20, wherein the difference in phase between the first portion of the radio signals and the second portion of the radio signals is 180 degrees.

22. The vehicular radar sensor of claim 20, wherein the first portion of the radio signals at least partially cancels the second portion of the radio signals to reduce reflected radio signals within a field of sensing of the vehicular radar sensor.

23. The vehicular radar sensor of claim 20, wherein a dimension of each cavity of the plurality of cavities is based on an operating frequency of the vehicular radar sensor.

24. The vehicular radar sensor of claim 20, wherein the internal surface of each cavity is at least partially covered by a metallic material.

25. A vehicular radar sensor, the vehicular radar sensor comprising:
a plurality of transmitters that transmit radio signals and a plurality of receivers that receive radio signals;
a printed circuit board (PCB) comprising electronic circuitry and associated software;
a radome at least partially enclosing (i) the PCB, (ii) the plurality of transmitters and (iii) the plurality of receivers;
wherein the radome comprises an internal side nearest the PCB, and wherein the radome comprises an external side farthest from the PCB that is separated from the internal side by a thickness of the radome;
wherein the radome comprises a plurality of cavities at the internal side of the radome that extend partially but not entirely through the thickness of the radome, and wherein a portion of the transmitters and a portion of the receivers extend into respective cavities of the plurality of cavities;
wherein radar data captured by the vehicular radar sensor is based on radio signals that (i) are incident at the external side of the radome, (ii) enter the radome and pass through the radome and (iii) are received by the receivers;
wherein a first portion of the radio signals incident at the external side of the radome enters the radome and reflects off an internal surface of the cavities, and wherein a second portion of the radio signals incident at the external side of the radome enters the radome and reflects off an outer side of the PCB that is closest to the internal side of the radome;
wherein the first portion of the radio signals has a phase that is different than a phase of the second portion of the radio signals; and
wherein the vehicular radar sensor is disposed behind one selected from the group consisting of (i) a fascia of a vehicle and senses through the fascia of the vehicle and (ii) a bumper of the vehicle and senses through the bumper of the vehicle.

26. The vehicular radar sensor of claim 25, wherein the difference in phase between the first portion of the radio signals and the second portion of the radio signals is 180 degrees.

27. The vehicular radar sensor of claim 25, wherein the first portion of the radio signals at least partially cancels the second portion of the radio signals to reduce reflected radio signals within a field of sensing of the vehicular radar sensor.

28. The vehicular radar sensor of claim 25, wherein the internal surface of each cavity is at least partially covered by a metallic material.

29. The vehicular radar sensor of claim 25, wherein each cavity of the plurality of cavities has a depth dimension, a height dimension, and a width dimension that is the same as the depth dimension, the height dimension, and the width dimension of each other cavity of the plurality of cavities.

30. The vehicular radar sensor of claim 29, wherein the depth dimension, the height dimension, and the width dimension are each based on an operating frequency of the vehicular radar sensor.

31. The vehicular radar sensor of claim 25, wherein each cavity of the plurality of cavities is separated from an adjacent cavity of the plurality of cavities by a gap dimension, and wherein the gap dimension is based on an operating frequency of the vehicular radar sensor.

32. The vehicular radar sensor of claim 25, wherein each cavity of the plurality of cavities has a cube shape.
